(19) United States
(12) Patent Application Publication
(10) Pub. No.: US 2009/0193674 A1
(43) Pub. Date: Aug. 6, 2009

(54) POSITION MARKING DEVICE FOR SLOT HANGERS

(76) Inventor: Amr Megahed, Schaumburg, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 12/365,222

(22) Filed: Feb. 4, 2009

Related U.S. Application Data
(60) Provisional application No. 61/026,329, filed on Feb. 5, 2008.

(51) Int. Cl. B25H 7/04

(52) U.S. Cl. 33/666

(57) ABSTRACT

A method of hanging an object on a wall with a marking device having a threaded shaft, an enlarged diameter head fixed at one end of the shaft, a pointed marking end fixed at an opposite end of the shaft, and a threaded nut mounted on the shaft for axial movement. The shaft of the marking device is positionable into the slot of the item to be hung, and is fixed therein by the nut. Upon positioning of the object and the marking device fixed thereto into desired mounted position on the wall, application of an axial force to the shaft of the marking device will cause a pointed end thereof to create a mark for insulation of a nail or other fastener in the wall at the point of the mark.

### CROSS-REFERENCE TO RELATED APPLICATIONS

This patent application claims the benefit of U.S. Provisional Patent Application No. 61/026,329, filed Feb. 5, 2008, which is incorporated by reference.

### FIELD OF THE INVENTION

The present invention relates generally to an apparatus and method for locating a nail, hook, or other fastener used for hanging or securing a picture frame, mirror, or other object on a wall, and more particularly, to an apparatus and method effective for marking the wall at the proper site for the hanging the object by means of a key hole slot or hanging hardware slot-like opening provided on a rear side of the object to be hung.

### BACKGROUND OF THE INVENTION

Hanging a picture frame, mirror, curtain frame, or other objects on a wall in a proper desired position can be a time consuming and frustrating process. It is common for persons wishing to hang a picture frame, for example, to hold the frame in the desired mounted position, and attempt with a finger, pencil or other object to locate and mark the correct location for installation of the hanging fastener in the wall. The method is highly imprecise, can be very awkward to carry out, and usually, the mark is only the approximate location of where the hanger should be placed. Such method has the additional disadvantage in that it makes disfiguring marks on the wall, often at locations far removed from the actual required hanger site.

When larger items are to be hung which have two or more key hole slot hangers or the like, the task becomes even more cumbersome, requiring the installer to measure the distance between the slots. The user must then transfer this measurement to the wall, with the hope that the spacing will line up with the nail or other fasteners mounted in the wall. The method requires considerable guess work and proves to be inaccurate in achieving a perfectly balanced finally hung product.

While a number of approaches have been proposed for locating the position of fastening nails or other hangers on the wall, these approaches also often have been cumbersome to carry out, required adhesives, strings, wires, or the like, or were not easily useable with key hole or other slotted hanger hardware. Such prior fastener locating devices also can be complicated and expensive for purchase for relatively infrequent household usage.

### OBJECTS AND SUMMARY OF THE INVENTION

It is an object of the present invention to provide a relatively simple apparatus and method for locating nails, hooks, or other fasteners used to support a picture frame, mirror, or other object on a wall.

Another object is to provide such an apparatus and method which is particularly adapted for hanging objects that have one or more key hole slot mounting openings or the like in a back side thereof.

A further object is to provide an apparatus and method of the above kind which can be used to precisely mount objects on a wall in desired balanced condition by a plurality of key hole slots or other slotted hanging hardware without measurement between the multiplicity of hanger slots.

Still anther object is to provide a marking device for use in the method of the invention that is simple and economical in construction and reliable in usage.

Other objects and advantages of the invention will become apparent upon reading the following detailed description and upon reference to the drawings, in which:

### BRIEF DESCRIPTION OF THE DRAWINGS

FIG. 1 is a perspective of a marking device in accordance with the invention;

FIG. 2 is a longitudinal section of the illustrated marking device taken in the plane of line 2-2 in FIG. 1;

FIG. 3 is a rear side perspective of an illustrative frame having key hole slot mounting plates;

FIGS. 4A-4D are perspectives illustrating the use of the marking device for applying wall markings for fastening nails or the like for hanging the illustrated frame;

FIGS. 5A and 5B are sequential views illustrating the use of such marking devices in securing a power strip to a wall or piece of furniture;

FIG. 6 depicts useage of the marking device with different forms of key hole slots; and

FIGS. 7-9 depict use of the marking device of the present invention with different forms of mounting hardware slots or the like.

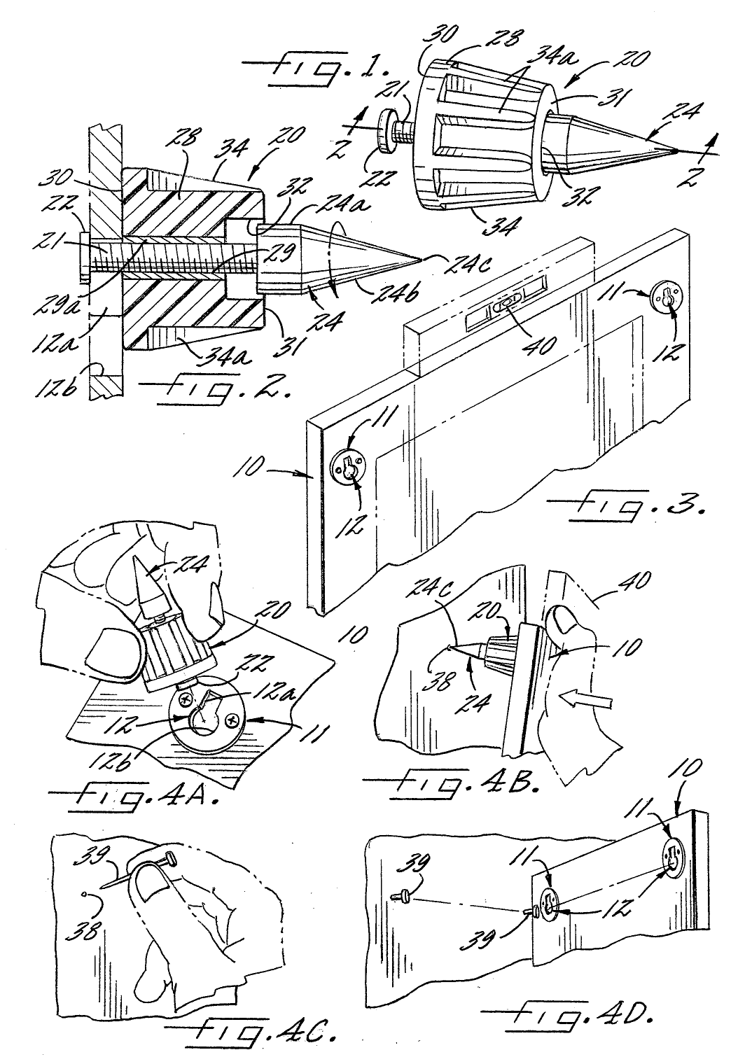

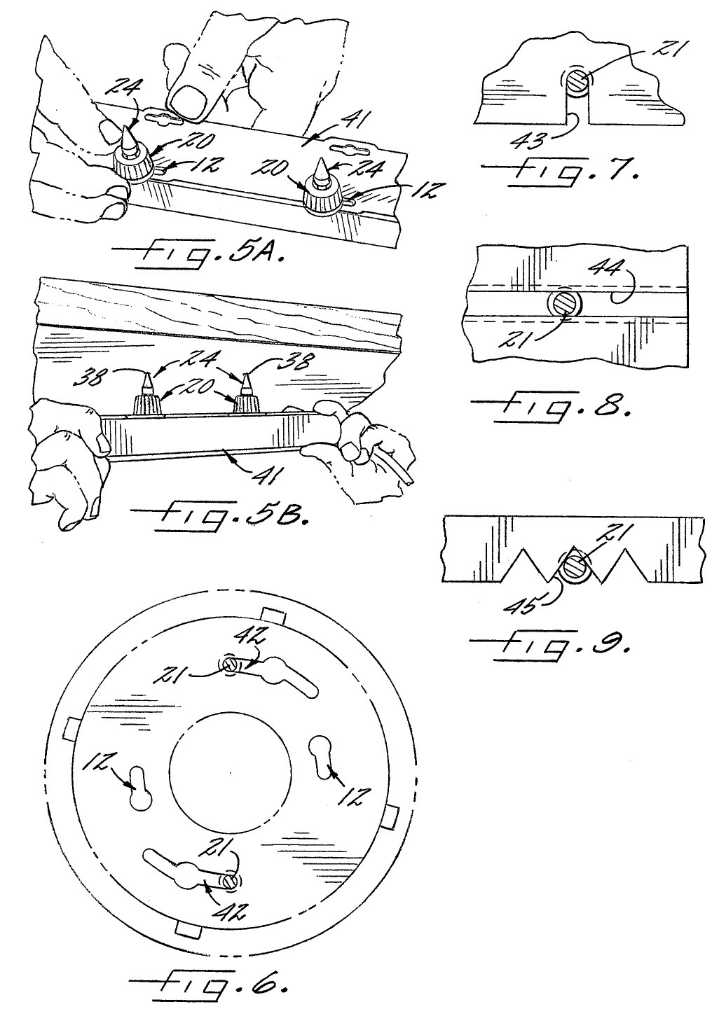

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative construct and equivalents falling within the spirit and scope of the invention.

### DESCRIPTION OF THE PREFERRED EMBODIMENTS

Referring now more particularly to the drawings, there is shown an illustrative frame 10 having a plurality of mounting plates 11 fixed on a rear side thereof. Each mounting plate 11 in this case is formed with a key hole mounting slot 12, having a relatively narrow width, vertically extending upper slot section 12a communicating with a relatively larger diameter, rounded bottom opening 12b. As understood by persons skilled in the art, such key hole slots 12 are adapted to receive the head or protruding end of a nail, screw, hook or like fastener secured in the wall, with the head or end of the fastener being positioned through the enlarged diameter rounded bottom section portion 12b, and with the smaller width slot section then being lowered down on to the shaft or stem of the fastener.

In accordance with the invention, a relatively simple marking device is provided that can be positively, but releasably secured, within a respective mounting slot of the object to be wall mounted for reliably marking the exact position on the wall for installation of a nail, hook, or like fastener, for proper hanging of the object. In the illustrative embodiment, a plurality of marking devices 20 are provided that each includes an elongated externally threaded shaft 21 having an enlarged diameter slot-engaging head 22 fixed at one end and an enlarged diameter marking end 24 fixed at its opposite end. The marking end 24 in this case has a cylindrical section 24a fixed to the end of the threaded shaft 21 opposite the head 22 and a conical-shaped terminal end 24b that defines a marking point 24c. The slot-engaging head 22 has diameter typical of a screw or nail head sized, smaller than the diameter of the enlarged diameter opening 12b of the key holed slot 12 of the mounting hardware 11 within which it is used, but greater than the width of the vertical slot section 12c. The head 22 is thereby positionable into the enlarged diameter opening 12b for enabling the shaft 21, which has a diameter less than the width of the vertical slot section 12a, to be moved upwardly to the top of the vertical slot section 12c. The threaded shaft 21, head 22, and marking end 24 preferably are economically formed of light weight aluminum.

In carrying out the invention, the marking device 20 has a nut 28 with an internally threaded bore 29 mounted on the threaded shaft 21 for axial movement between the positions adjacent marking end 24 and the slot-engaging head 22 as an incident to rotational movement of the nut 28. The nut 28 preferably is a lightweight, plastic injection molded piece formed with an internally threaded aluminum bore insert 29a, an end face 30 facing the slot-engaging head 22, and an opposite end face 31 facing the marking end 24. The end face 30 preferably is substantially larger than the head 22, having a relatively large engagement surface with the slot defining mounting plate. In the illustrated embodiment, the end face 30 has a diameter of at least three times the diameter of the head 22. The opposite end face 31 in this case is formed with a counter bore 32 for receiving at least a portion of the cylindrical section 24a of the marking end 24 when the nut 28 is moved to a position adjacent the marking end 24. The illustrated nut 28 has a frusto-conical outer surface 34 tapered inwardly in a direction toward the marking end 24 and having a plurality of longitudinally oriented ribs 34a to facilitate gripping and rotation of the nut during usage. As will become apparent, the inward taper allows the user to grip the nut while still observing the marking end 24 of the device.

In carrying out the method of the invention, the slot-engaging head 22 of the marking device 20 is insertable into the enlarged diameter opening 12b of the key hole slot with the nut 28 advanced to a position away from the screw head 22 enabling the shaft 21 to be moved upwardly to the top of the vertical slot section 12a of the mounting plate 11. The nut 28 can then be rotated into engagement with the rear face of the mounting plate 11, with the mounting plate 11 being secured between the end face 30 and head 22 on opted sides of the slot. It will be understood that such an adjustable nut 28 enables the marking device to accommodate different thicknesses of mounting hardware within which the key hole slot is formed. A marking device 20 may similarly be secured on the slot of the other mounting plate 11.

The frame 10 can then be positioned into a desired location on the wall on which it is to be mounted, and once that position is decided upon, the frame, and hence the marking devices, may be forced against the wall, with the sharp points 24c of the marking ends 24 making a small mark or pilot hole 38 in the wall. Upon removal of the frame 10 from the wall, fastening nails 39, screws, or hooks may be installed at the marked positions, which will automatically establish the proper desired mounting of the frame.

To ensure precisely level mounting of the frame or object on the wall, a level 40 may be positioned on the upper edge of the frame 10, pressure may be applied to the marking device 20 on one side of the frame, the frame can be pivoted about that point until the upper edge is precisely level, and pressure can then be applied to the other marking device to establish the second fastener location. In lieu of a conventional level, a laser leveling device alternatively could be used.

FIGS. 5A and 5B disclose an alternative useage of the marking devices. In this case, the marking devices are used in key hole slots of a power strip 41 which is being mounted onto the wall of a desk or the like. It will be understood that the marking devices may be used in many other applications in which it is desired to pre-mark the location of hanging or mounting fasteners.

While the invention has been shown with anchors having key hole slots 12, it will be understood that other hanging slot configurations could be used, such as the double arcuate slots 42 on the back side of a smoke detector as shown in FIG. 6, a bottom opening slot 43 as shown in FIG. 7, a side opening slot 44 as shown in FIG. 8, or a saw tooth recess slot 45, as shown in FIG. 9. In each case, the threaded shaft 21 of the marking device can be positioned into the slot and the nut 24 rotated to secure the marking device in the slot with the slot defining mounting portion of the object secured between the end face 30 of the nut 24 and the head 22.

From the foregoing, it can be seen that a relatively simple marking device and method is provided for locating nails, hooks, or other fasteners on the wall for supporting an object on the wall by means of key hole slots or like mounting openings in a rear side of the frame or object. The locating devices are relatively simple and economical in construction and are easy and reliable in usage.

1. A marking device for use in locating a fastener in a wall for hanging an object having a mounting portion formed with a slot from which the object can be hung on the wall by a fastener comprising an externally threaded shaft having an enlarged diameter slot engaging head fixed at one end and an enlarged diameter marking end fixed at an opposite end, said marking end being formed with a pointed terminal end for effecting a marking on the wall when the shaft is subjected to axial force, a nut mounted on the externally threaded shaft for movement as an incident to rotation relative to shaft between, a retracted position away from said head for enabling said exposed section of the shaft to be positioned into the slot of the mounting portion of the object to be hung with the head on one side of the slot and the nut on the other side of the slot for enabling the shaft to be positioned within the slot of the hanging portion and a second position in which the head is in engaging relation with the mounting portion for positively securing the marking device in the slot such that the object and the marking device may be simultaneously positioned to a desired mounted position on the wall at which location axial pressure can be exerted on the marking device for marking the location on a wall mounted fastener.

2. The marking device of claim 1 in which said marking end includes a cylindrical section fixed to said threaded shaft and a conical end portion defining said pointed terminal end.

3. The marking device of claim 2 in which said conical portion of said marking end has a diameter larger than the diameter of said head.

4. The marking device of claim 3 in which said conical portion of said marking end has a diameter of at least three times the diameter of said slot engaging head.

5. The marking device of claim 1 in which said nut has a frustro conical configuration tapered inwardly in the direction toward said marking end.

6. The marking device of claim 5 in which said nut is formed with a ribbed gripping surface.

7. The marking device of claim 1 in which said nut has an end face formed with a counter bore for receiving at least a portion of the marking end when said nut is positioned adjacent the marking end.

8. The marking device of claim 1 in which said shaft, slot engaging head, and marking end are made of metal, and said nut is made of plastic.

9. A method of hanging an object on a wall comprising the steps of:
providing a mounting portion with a slot on a rear side of the object to be hung,
providing a marking device having a threaded shaft, an enlarged diameter head at one end of the shaft, a pointed marking end fixed at an opposite end of the shaft, and a threaded fixed nut mounted on the shaft for movement between positions adjacent the head and marking end as an incident to rotation thereof,
rotating said nut to a position away from said head to expose a section of said threaded shaft,
positioning the exposed threaded shaft section into said slot,
rotating said nut in a direction into engagement with said hanging portions on a side opposite said head such that said marking device is positively secured in position on said slot,
positioning said object into a desired position for mounting on said wall,
applying an axial force to the shaft of the marking device to cause the pointed end of the marking end to create a mark on the wall, and
installing a fastener on the wall at the point of said marks.

10. The next method of claim 9 including providing a mounting portion having a slot in the form of a key hole slot having an elongated section with an enlarged diameter rounded portion at one end, and positioning the head of the shaft of the marking device through the enlarged diameter portion of the key hole slot and then positioning the shaft into the elongated section of the slot.

11. The method of claim 9 including providing a mounting portion with slot in the form of a bottom opening slot, and upwardly moving the shaft of the marking device into the slot from the underside thereof.

12. The method of claim 9 including providing a mounting portion with a slot in the form of a side opening slot, and positioning the threaded shaft of the marking device into the slot from a side thereof.

13. The method of claim 9 including providing a mounting portion with a slot in the form of a downwardly opening saw tooth configuration, and positioning the threaded shaft into an opening defined by the saw teeth configuration.
